(19) United States
(12) Patent Application Publication
(10) Pub. No.: US 2008/0127684 A1
(43) Pub. Date: Jun. 5, 2008

(54) Release for Fastening Assembly

(75) Inventors: Dickory Rudduck, Chicago, IL (US); Lee David Blattmann, Wilmette, IL (US)

Correspondence Address: HEATHER AKARTSOUNES, 520 W. ERIE STREET, SUITE 210, CHICAGO, IL, 60610, US

(73) Assignee: TELEZYGOLOGY INC., CHICAGO, IL (US)

(21) Appl. No.: 11/571,899

(22) PCT Filed: Jul. 14, 2005
(86) PCT No.: PCT/AU05/01024

§ 371 Date: Jan. 10, 2007

(30) Foreign Application Priority Data
Jul. 14, 2004 (AU) 2004903861
Aug. 13, 2004 (AU) 2004904582
Apr. 4, 2005 (AU) 2005901636

(51) Int. Cl. E05B 49/00

(52) U.S. Cl. 70/77; 292/262; 70/277

(57) ABSTRACT

A fastening assembly (110) including: an engagement means including latch means (130) and locking means. (132), the engagement means being moveable between a s locking position (see FIG. 9) and an unlocking position (see FIG. 10); first biasing means (136) urging the engagement means towards the locking position; drawing means (1.46) for drawing the engagement means from the locking position to the unlocking position, the drawing means (146) comprising or including material adapted to contract when activated; release means (220, see FIG. 14) for moving the locking means (132) to the 10 unlocking position; second biasing means (222, see FIG. 14) urging the release means (220) towards the locking means (132); and restraining means (224, see FIG. 14) for restraining the release means (220) against the urging of the second biasing means (222).

### FIELD OF INVENTION

This invention relates to fastening assemblies, including in inline and other fasteners. This invention is concerned, not necessarily exclusively, with fastening assemblies which can be useful for locks, latches, closures and the like.

### BACKGROUND ART

The following references to and descriptions of prior proposals or products are not intended to be, and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

Th present invention has a variety of applications, most typically involving confined spaces where fastener assemblies or devices are required. For example in transport vehicles such as marine, naval, train, aircraft, aerospace or automobile cabins, or in electronic devices where the demand for miniaturisation is ever-increasing, prior art fastener assemblies have been impractical or unsatisfactorily bulky. For some applications, a fastener assembly with a sufficiently slim profile has nit been available which would be able to be concealed within elements having at least one narrow dimension, for example, having a thickness of between 15 and 20 mm. Moreover, a significantly more compact fastener assembly would find uses in a variety of applications. Persons skilled in the art will appreciate that although the invention and its preferred embodiments will be described below with reference an aircraft cabin application, the scope of the invention is not necessarily limited to this application.

In present aircraft design, most fasteners are designed to be hidden behind doors, panels, etc. It is common to include a manual release for a hidden fastener, whereby a tool can be inserted through a small aperture visible from the cabin side of the door, panel or the like.

It is an object of this invention, at least in one embodiment, to provide a fastener so assembly which can be manually released if desired.

### DISCLOSURE OF INVENTION

Fastener Assembly Actuated be Contractible Material

In Australian Patent Application No. 2004903861, there was disclosed a fastener assembly. The entire contents of Patent Application No. 2004903861 are imported herein by reference. In this application there was provided a first fastener assembly including:
an engagement means movable between a locking position and an unlocking
biasing means urging the engagement means towards the locking position; and
means for drawing the engagement means from the locking position to the unlocking position,
   wherein the drawing means comprises or includes material adapted to contract when activated.

The fastener assembly is preferably capable of construction on a small scale so that, possibly with the exception of the engagement means, it has a cross sectional dimension of about 10 mm. The purpose of this is so that the fastener assembly can be inserted into a panel, such as a panel for an aircraft electronics or automobile cabin, which has a thickness of around 15 to 20 mm. It is of course possible to provide the fastener assembly of the invention on a larger scale for other purposes.

Preferably, the engagement means includes latch means and, locking means. The latch means and locking means of the engagement means may take any desirable configuration. An example is illustrated in the accompanying drawings referred to in the detailed description below. By way of non-limiting illustration, the latch means may include a pa of arms or jaws which can engage a latch, bar or projection. Other configurations will be apparent to one skilled in the art.

The locking means is preferably a slidable shuttle in which the latch means is generally received. In a preferred embodiment the locking means has a pair of arms adapted to embrace the latch means in the locking position and to hold the latch means in locking contact with the latch, bar or projection. In this embodiment, drawing of the shuttle away from the latch means is designed to allow the latch means to release contact with the latch, bar or projection.

The engagement means may take any desirable configuration. Some examples are illustrated in the accompanying drawings referred to in the detailed description below. By way of non-limiting illustration, the engagements means may include a pair of arms or jaws which can engage a latch, bar or projection. By way of different illustration, the engagement means may include a rod or tongue which bears against a closure, preventing movement of the closure towards the engagement means when the engagement means is in a locking position, or a cavity into which the rod or tongue may be received in the locking position.

The engagement means further preferably includes a pawl to facilitate rapid resetting of the fastener assembly after activation of the drawing means: In this embodiment, the fastener assembly of the invention can eliminate unnecessary delay between sequential unlocking and locking actions. It is also an option that this facility can be cancelled if rapid locking followed by unlocking is not desirable.

Preferably, the fastener assembly of the invention includes means for indicating the locked or unlocked states of the fastener assembly. By way of a non limiting example, this can be effected by micro switches in contact with the shuttle or an extension thereof. Information as to the locked or unlocked status of the fastener assembly can be conveyed to an indicator light or similar indicium locating in a convenient position.

The biasing means urging the engagement means towards the locking position may be any suitable biasing device such as a band or block made of a resiliently deformable material such as natural or synthetic rubber, or may include a leaf, spiral or coil spring. The biasing means is preferably a coiled spring. The biasing means may be positioned in the fastener assembly of the invention so that the spring urges the engagement means, such as the shuttle, toward the locking position. When the means for drawing the engagement means from the locking position to the unlocking position is activated, this may cause compression of the spring, which accordingly can return the engagement means towards the locking position once the drawing means is no longer activated. Of course, it will be apparent to the skilled person that a reverse arrangement is within the scope of the invention in which the fastener assembly is biased to the unlocked position and activation is required to urge the engagement means to the locked position.

It is preferred that the fastener assembly of the invention includes additional biasing means, such as a spring attached to the pawl and a spring for ejecting the latch, bar or projection.

The drawings means itself consists of or includes material adapted to change shape when activated, typically by expanding or contracting. Such materials include various shape-memory alloys and polymers, electrostrictive materials, magnetostrictive materials, thermosensitive, photosensitive and piezoelectric materials. Preferably, the drawing means contract when activated. This material is preferably shape memory alloy wire. Shape memory alloys are known and are usually made predominantly or wholly of titanium and nickel. They may also include other material, such as aluminize, zinc and copper. A shape memory alloy is capable of adopting one shape below a predetermined transition temperature and changing to a second shape once its temperature exceeds the transition temperature. Conversely, when the shape memory alloy cools below the transition temperature, it is capable of adopting the first shape again. Of course, where applications inherently involve high temperatures such as automobile engine or external aerospace applications, types of shape memory materials other than such temperature sensitive shape memory alloys will be more suitable.

Shape memory alloy wire, such as that sold under the trade mark Nitinol, is capable of contracting by about 3 percent when activated by heating. Consequently, in order to provide sufficient “travel” in drawing the engagement means from the locking position to the unlocking position, the drawing means may include Nitinol wire in a single, relatively long single, double or multiple, preferably parallel, line and a fastener assembly having this configuration may be referred to as an “inline” fastener assembly. This configuration enables the fastener assembly to have a slim profile, for the purpose of fitting into panels and similar elements, as referred to above.

In other applications, particularly where a slim profile is not a priority, or in those circumstances where a greater amount of “travel” of the engagement means is desirable, he Nitinol wire may be provided over a non-linear path. This may have the effect of permitting the fastener assembly of the invention to be provided in a more compact configuration compared to the inline fastener assembly referred to above. In addition, if, for example, the length of Nitinol wire in a nonlinear path was around 200 mm, the amount of contraction of Nitinol in its presently available font would be about 6 mm, i.e. 3%. In a non-linear path, the Nitinol wire preferably loops over one or more spindles or rollers. An example is shown in the accompanying drawings referred to in the detailed description below.

The scope of the invention in its various aspects is not necessarily limited to the use of shape memory alloy. Other material may also be useful. Also, while activation may take place through heating, other means of activation may be suitable and are within he scope of this invention. The means of activation of the drawing means material therefore is inherently dependent on the type of shape memory material used and the type of application constraints involved (for example, where temperature, light, electromagnetic fields or electrostatic issues are constraining factors). Preferably, the shape memory material is adapted to contract when activated and, where heat sensitive shape memory alloys are used, this is preferably achieved through electrical resistance heating, with a wire feed to the fastener assembly.

The fastener assembly of the invention may include many other options. One such option is the sensing of a change in temperature, for example to indicate a dangerously high temperature, so that an appropriate alarm can be initiated, the fastener assembly of the invention being wired into, for example, the aircraft electrical system. Other sensing s functions may be incorporated in the fastener assembly of the invention. The fastener assembly may be remotely activatable, such as by a radio control device. The fastener assembly may be hard wired to a controlling device. The fastener assembly may be communicatively linked to a computer system optionally controlling the activation of one or more fastener devices.

The drawing means way be changed for a particular fastener assembly to suit a particular application for example where a different activating factor is required to be employed or a higher gauge drawing means is required. The drawing means way include dual shape memory devices adapted to be activated in different circumstances. As a failsafe, the fastener assembly may include opposed shape memory devices, one biased to the open position and one to the closed position, whereby positive actuation of both shape memory devices is required to effect a change in position of the engagement means. Alternatively, the fastener assembly may include dual or multiple engagement means controlled by corresponding drawing means in which the one or more engagements must be simultaneously activated to permit the release of the fastener assembly or the component secured thereby. The same engagement means may be joined to a joining means wit Nitinol wire of a first gauge, or to different drawing means with Nitinol wire of a second gauge, thus affecting the strength of the drawing means. As another example, the drawing means having a single Nitinol wire may be replaced with a drawing means having two Nitinol wires for redundancy.

Accordingly, the fastener assembly may have inbuilt redundancy by including one or more additional material which contract when activated, such as Nitinol wire. Any of the Nitinol wires would be able to contract when activated. The fastener assembly may therefore include multiple drawing means. This can provide redundancy, so that if activation of one drawing means, such as a Nitinol wire, fails to operate the assembly, so the other or another of the drawing means can be activated to perform the necessary drawing means function.

The fastener assembly may be constructed in modular form. For instance, the engagement means may form one module, with the drawing means being located in a separate module. One engagement means, which may be in the form of a pair of jaws, may be changed for engagement means which includes a rod, for instance. This allows interchangeability so as to permit different types of latch means to be exchanged in the fastener assembly of the invention, or to substitute, for example, a single drawing means with a multi-strand drawing means, or a heat activated drawing means for a light activated drawing means module.

One application of the fastener assembly of the invention is to provide fastening of an element—such as a panel, door or the like—in which the fastener assembly is mounted to an external element, such as a latch. As will be appreciated, the engagement means and its type of engagement with the external element may take many different forms. The drawing means may be attached directly to the engagement means or to an intermediate body. This allows a certain amount of flexibility in the design of the engagement means.

The fastener assembly is preferably enclosed in a housing which can be bonded or fitted into the panel, door or the like. This arrangement can assist in photo, thermal or electromagnetic protection, can facilitate exchange of one fastener assembly with another and can enable better adjustment of the fastener assembly within its surroundings. This can be particularly important if the fastener assembly of the invention includes facility for manual release as mentioned above. It can also permit the status (locked or unlocked) indicator to be visible from the same aperture which can be used for manual release.

Another application of the fastener assembly is to provide a fuel filler catch in a vehicle. The fastener assembly of the invention may be contained within or close to the fuel filler cavity and effectively concealed from the outside of the vehicle. In this embodiment the engagement means preferably comprises a rod or tongue which, while the engagement means is in the locking position, prevents removal of the fuel filler cap. Alternately, the engagement means may retain the fuel filler cap through engagement with a latch or similar element on the fuel filler cap.

When the material adapted to contract when activated, such as Nitinol wire, is heated electrically to the desired temperature, the drawing means draws the engagement means out of engagement with the fuel filler cap, allowing removal of the fuel filler cap. Because the engagement means is biased towards the locking position, once the material adapted to contract when activated is no longer activated—for example, when it is allowed to cool, the fuel filler cap may be pushed back into engagement with the engagement means.

In some embodiments of the fastener assembly, the drawing means is attached to an electrical system, Use may be made of this so that the fastening system has a switching capacity as a second function. For example, the fastening system may also operate to turn lights on or off. This way occur in coordination with the locking/unlocking function of the fastening system or independently

One use of the fastening assembly of the invention is to fasten a closure such as a door in an aircraft, typically for a dogbox or cupboard. The fastening system, of the invention may be configured so that, when the engagement means is drawn to the unlocking position, allowing the door to open, the fastening system also causes a light in the dogbox or cupboard to be turned on. Similarly, when the engagement means moves to the locking position, the fastening system may cause the light to be turned off.

In another embodiment, the fastening system includes or is associated with a sensing means, which senses light or temperature (internally or externally of the location of the fastening system), or stress applied to the fastener or its environment. In the case of light sensing, the fastening system may be programmed to turn lights (eg, in the cupboard or doghox) on or off, depending on the amount of external light sensed. Of course, in such au application the drawing means material, itself, may be light activated, although preferably it is controlled by other factors and the light sensing device is a separate component of the fastener assembly or its controlling device. In the case of stress sensing, the sensor may detect stress applied to the fastening system, and report on impending failure of the fastening system, for example. Other embodiments will be apparent to one skilled in the art.

The fastening system of the invention may be networked with others fastening systems, for any desirable purpose, but especially so that failure or overstressing of one fastening system may be compensated for by another fastening system in the network.

Fastener Assembly with Protection for Contractible Material

Advantageously, there may be provided a second fastening assembly adapted to protect the drawing means from damage and applies not only to the first fastener assembly described above, but to other applications in which a material adapted to contact when activated is required to pull on an element.

Material such as Nitinol is rated according to its composition. For example, a 330 g Nitinol wire may have a pull force of 3.3 Newtons. If this wire is configured so as to pull on an element and the element is blocked from movement to a sufficient extent, the Nitinol wire may be capable of exerting a further pull force of, say, 9 Newtons. By this stage, however, the Nitinol wire may be in danger of being damaged. The invention in its second aspect has as an object the prevention or amelioration of such damage.

In Australian Patent Application No. 2004904582, there was disclosed a fastener assembly. The entire contents of Patent Application No. 2004904582 are imported herein by reference. Reference is also made to International Patent Application No. PCT/AU2004/001580, the entire contents of which are also imported herein by reference. In Patent Application No. 2004904582, there was provided a second fastening assembly including a stain reduction assembly including:
a material adapted to contract when activated, the material having:
   a first pull force at which fe material is adapted to move an element to which the material is directly or indirectly connected;
   a second pull force greater than the first pull force; and
   a third pull force intermediate the first pull force and the second pull force; and
means adapted to be activated when the pull force on the material has reached substantially the third pull force.

The material adapted to contract when activated may include any material described above in relation to the drawing means, but is preferably the Nitinol wire referred to above. The first, second and third pull forces will depend on the rating of the Nitinol wire. By way of example, if the rating is around 3.3 Newtons, this will represent the first pull force. The second pull force in this example will be around 9 Newtons while the third pull force will be around 4.5 Newtons. Ideally, the third pull force is approximately one and a half times greater than the first pull force and calculated to be less than the second pull force, which may be calculated as that capable of causing damage to the material.

The element to be moved by the material adapted to contract such as the Nitinol wire may be any appropriate element. In the context of the first fastening assembly, the element is the engagement means. As stated above, this second protection aspect is not limited to the description provided in relation to first fastening assembly and consequently the invention in its second aspect has wide application.

The means adapted to be activated when the pull force is substantially the third pull force may be a compression spring or other device described above in relation to the biasing means attached to the material. The compression spring is preferably of any suitable construction. However, the means adapted to be activated at the third pull force may take other forms. By way of non limiting example, the means may include monitoring resistance in the Nitinol wire and cutting of electrical power once the resistance has changed by, say, twenty percent. Accordingly, the drawing means such as Nitinol wire can be protected from damage.

Release for Locking Assembly

In the invention, modifications are made to the first and second fastener assemblies referred to above. The fastener assemblies described above are not acknowledged prior art, and no concessions are made in relation to the novelty and inventive step thereof. Indeed, the fastener assemblies referred to above are considered to form part of the precursive developmental process that lead to the main invention described below. The fastening assemblies referred to above will be generically referred to hereinafter as “the original latch system”.

The present invention achieves modifications to the original latch system. Accordingly, the present invention provides a fastening assembly including:
an engagement means including latch means and locking means, the engagement means being moveable between a locking position and an unlocking position;
first biasing means urging the engagement means towards the locking position;
means for drawing the engagement means from the locking position to the unlocking position, the drawing means comprising or including material adapted to contract when activated;
release means for moving the locking means to the unlocking position;
second biasing means urging the release means towards the locking means, and
means for restraining the release means against the urging of the second biasing means.

In the description below, reference will be made to these variations in the context of locking of crew rest compartments in aircraft. It is to be understood, however, that the invention is not limited to this application and that the invention can be useful in a wide variety of situations.

To ensure privacy for crew members, and to enhance security, it is desirable to provide a locking system, suitable for crew rest compartments, and which has various features. The locking system should lock automatically when the crew door is closed. Optionally, the locking system should be capable of accommodating an electro-mechanical interlock controlled by an autonomous electronic alpha-keypad. In addition, the locking system should incorporate an override mechanism which can be operated from either side of the crew compartment door, namely from inside the compartment and from outside the compartment Further, the locking-system, if it is to be electrically powered, should be designed so that it can be unlocked in the event of a power breakdown.

The original latch system is eminently suitable for adaptation to the desirable characteristics listed above for a crew compartment door on an aircraft. The original latch system can have many benefits over prior art electro-mechanical latches, such as low weight (the original latch system can be manufactured in weights of less than 150 g), the ability to be “locked down” from a remote location, the fact that the original latch system may be completely silent, the option of incorporation of a manual-override mechanism, the ability to make the original latch system with a narrow profile of, say, less than 10 mm thick, to allow for flush mounting into monuments, other structures and fascias, and the ability to network the original latch system with other original latch systems and/or “slave” unit latch points. The latch means and locking means of de engagement means may take any desirable configuration. An example is illustrated in the accompanying drawings. By way of non-limiting illustration, the latch means may include a pair of arms or jaws which can engage a latch, bar or projection. Other configurations will be apparent to one skilled in the art.

The locking means is preferably a slidable shuttle in which the latch means is generally received. In a preferred embodiment, the locking means is adapted to embrace the latch means in the locking position and to hold the latch means in locking contact with the latch, bar or projection. In this embodiment, drawing of the shuttle away front the latch means is designed to allow the latch means to release contact with the latch, bar or projection.

The engagement means further preferably includes a pawl to facilitate rapid resetting of the fastener assembly after activation of the drawing means. In this embodiment, the fastener assembly of the invention can eliminate unnecessary delay between sequential unlocking and locking actions. It is also an option that this facility can be cancelled if rapid locking followed by unlocking is not desirable.

Preferably, the fastener assembly of the invention includes means for indicating the locked or unlocked states of the fastener assembly. By way of a non limiting example, this can be effected by micro switches in contact wit the shuttle or an extension thereof. Information as to the locked or unlocked status of the fastener assembly can be conveyed to an indicator light or similar indicium located in a convenient position.

The first biasing means urging the engagement means towards the locking position is preferably a coiled spring, positioned in the fastener assembly of the invention so that a the spring urges the engagement means, such as the shuttle, toward the locking position. When the means for drawing the engagement means from the locking position to the unlocking position is activated, this may cause compression of the spring, which accordingly can return the engagement means towards the locking position once the drawing means is no longer activated.

It is preferred that the fastener assembly of the invention includes additional biasing means, such as a spring attached to the pawl and a spring for ejecting the latch, bar or projection.

The drawings means itself consists of or includes material as described above in relation to the first and second fastener assemblies. The drawing means may therefore be is adapted to contract when activated. This material is preferably shape memory alloy wire, such as Nitinol wire.

Activation of the shape memory alloy wire can be initiated from a central location, using the wiring system of, for example, all air craft or automobile. It is also within the scope of this invention that the activation is initiated by remote means, such as a hand held tool operating trough the use of any suitable form of energy, including microwave, electric magnetic, sonic, infra-red, radio frequency and so on.

The release means may take any suitable form but is preferably a release pin which is of sufficient length to contact the locking means to disengage it from the latch means, whereupon the latch is able to open.

The second biasing means urging the release means towards the locking means is preferably a coil spring.

The means for restraining the release means against the urging of the second biasing means is preferably a solenoid electromagnet. Preferably, the fastener assembly of the invention is electrically operated. In the normal “power on” condition, the solenoid will be active and will hold back the second biasing means for the latch release pin, so that the fastener assembly can operate normally, for example through access keypad control. Conversely, if a “power off” mode is experienced, the solenoid will become inactive and the second biasing means, the spring, will release, causing the latch release pin to drive forward into the fastener assembly to override the locking mechanism, thereby releasing the door.

It is also within the scope of tins invention to provide for a mechanical override to allow mechanical release of the fastener from within the compartment under all conditions, including “power on” mode.

The fastener assembly of the invention may be configured so that it is hermetically sealed and so that it operates a dead bolt latch. In this configuration, the fastener assembly of the invention may enable a door to be dead bolted, latched without being dead bolted, released normally and released during an emergency, such as dog a “power down”. It is an option in any of the last three-mentioned states that the cabin side of the door may be provided with a handle for manually opening or closing the door. In addition, it is anticipated that, as mentioned above, keypads will be provided for access to and from the compartment.

The fastener assembly of the invention may include many other options. One such is option is the sensing of change in temperature, for example to indicate a dangerously high temperature, so that an appropriate alarm can be initiated, the fastener assembly of the invention being wired into, for example, the aircraft electrical system. Other sensing functions may be incorporated in the fastener assembly of the invention.

The fastener assembly of the invention may include multiple drawing means. This can provide redundancy, so that if activation of one drawing means fails to operate the assembly, the other or another of the drawing means can be activated.

The fastener assembly of the invention may be constructed in modular form. For instance, the engagement means may form one module, with the drawing means being located in a separate module. This allows interchangeability so as to permit different types of latch means to be exchanged in the fastener assembly of the invention, or to substitute, for example, a single drawing means with a multi-strand drawing means.

The fastener assembly of the invention is preferably enclosed in a housing which can be bonded or fitted into the panel, door or the like. This arrangement can assist in electromagnetic protection, can facilitate exchange of one fastener assembly with another and can enable better adjustment of the fastener assembly within its surroundings. This can be particularly important if the fastener assembly of the invention includes facility for manual release as mentioned above. It can also permit the status (locked or unlocked) indicator to be visible from the same aperture which can be used for manual release.

The invention in its various aspects will now be described in connection with certain non-limiting examples thereof, set out in the accompanying drawings.

### BRIEF DESCRIPTION OF THE DRAWINGS

In the drawings:

Fastener Assembly Actuated by Contractible Material

FIG. 1 is a cross sectional view of a first embodiment of the fastener assembly according to the invention, in the locking position;

FIG. 2 is an end view of the latch which is shown in FIG. 1;

FIG. 3 is a cross sectional view of the embodiment of FIG. 1 in the locking position,

FIG. 4 is all end view of the embodiment in FIG. 3, taken along the line 4-4 in FIG. 3;

FIG. 5 is a side sectional view of a second embodiment of the fastener assembly according to the invention; and

FIG. 6 is a side sectional view of a third embodiment of the fastener assembly according to the invention, showing a manual override.

Fastener Assembly with Protection for Contractible Material

FIG. 7 is a side sectional view of a fourth embodiment of the fastener assembly of the invention in the locked position, also illustrating a strain reduction assembly;

FIG. 8 is a top sectional view of the assembly of FIG. 7;

FIG. 9 is an enlarged view of the left hand end of the assembly in FIG. 7;

FIG. 10 shows the assembly of FIG. 9 as soon as the unlocking position has been attained;

FIG. 11 shows the assembly of FIG. 10 during cooling of the drawing means; and

FIG. 12 shows the assembly of FIG. 11, fully reset in the open position ready to move to the locking position and if required to unlock again immediately.

Release for Locking Assembly

FIG. 13 shows in perspective view a modified version of manual override which could be used with the latch system of the fourth embodiment;

FIG. 14 shows in sectional side elevation a fifth embodiment of release means, second biasing means and restraining means for use in relation to the original latch system, in “power on” mode;

FIG. 15 shows the assembly of FIG. 14 in “power off” mode;

FIG. 16 shows in exploded perspective view a sixth embodiment of the fastening system of the invention, from the exterior of the crew compartment;

FIG. 17 shows in larger detail the escutcheon plate on the exterior of the compartment door;

FIG. 18 shows the corresponding escutcheon plate on the interior of the compartment door;

FIG. 19 is a side elevation of the assembly of FIG. 16, from the interior of the cabin and showing the dead bolt state;

FIG. 20 is the same view, but showing the latched state;

FIG. 21 shows the open state; and

FIG. 22 shows the power down or emergency release state.

### DETAILED DESCRIPTION OF THE DRAWINGS

Fastener Assembly Actuated by Contractible Material

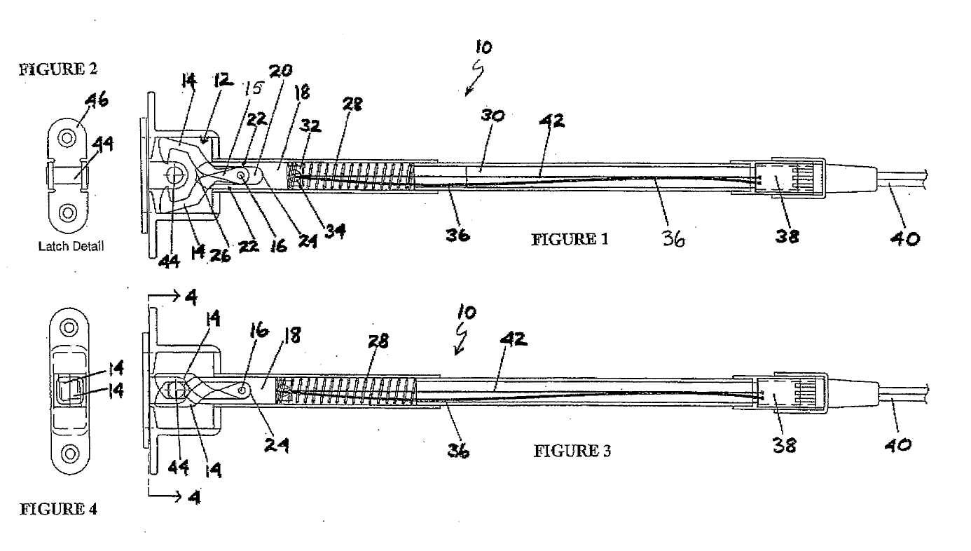

Turning first to FIGS. 1 to 4, fastener assembly 10 has engagement means 12 movable between the locking position shown in FIG. 3 and the unlocking position shown in FIG. 1.

Engagement means 12 includes a pair of jaws 14 extending via extension arms 15 from, and pivotable at, pivot point 16. Block 18 includes cavity 20 defined by arms 22, base 24 and stop 26.

When engagement means 12 is in the locking position as illustrated in FIG. 3, pivot point 16 lies as close to base 24 as possible and stop 26 does not prevent the closing of jaws 14, as illustrated. In contrast when engagement means 12 is in the unlocking position shown in FIG. 1, pivot point 16 is spaced from base 24 and stop 26 forces apart jaws 14, as illustrated.

Block 18 is urged towards engagement means 12, in the locking position, by coil spring 28 which is positioned between block 18 and tube 30, Block 18 includes projection 32 containing aperture 34 to which is attached smart memory alloy wire 36. Smart memory alloy wire 36 is connected electrically to element 38 which in turn is hard wired via wires 40 to an energy source (not shown). Wire 42 completes the circuit for smart memory alloy wire 36.

Fastener assembly 10 is intended to be inserted into the edge of a panel through a round in hole or bore in the panel, with wires 40 projecting from the rear of the panel. Jaws 14 engage latch 44 on external element 46, in order to secure the panel (not shown) to the external element.

To attach the panel to the external element, smart memory alloy wire 36 is energised by the external energy source via wires 40 to cause smart memory alloy wire 36 to heat and 16 contract to the position shown in FIG. 1. In this position, block 18 has been drawn back so that stop 26 forces jaws 14 apart. The panel is positioned so that jaws 14 are poised around latch 44. At this stage, power to smart memory alloy wire 36 is cut off and smart memory alloy wire 36 cools and elongates to the configuration shown in FIG. 3. Coil sprig 28 pushes block 18 to the left (towards latch 44). Stop 26 is no longer bearing against the base of jaws 14 and accordingly jaws 14 close as shown in FIGS. 3 and 4, engaging latch 44. In this way, the panel is fastened to the external element 46.

To remove the panel, smart memory alloy wire 36 is again energised so that it heats and contracts and fastener assembly 10 assumes the position shown in FIG. 1, releasing jaws 14 from latch 44.

As will be apparent to one skilled in the art, the design of engagement means 12 cam be varied considerably from that shown in FIGS. 1 to 4, as can latch 44. Engagement means 12 and block 18 may be provided as a module, replaceable by a different module with a different engagement mechanism.

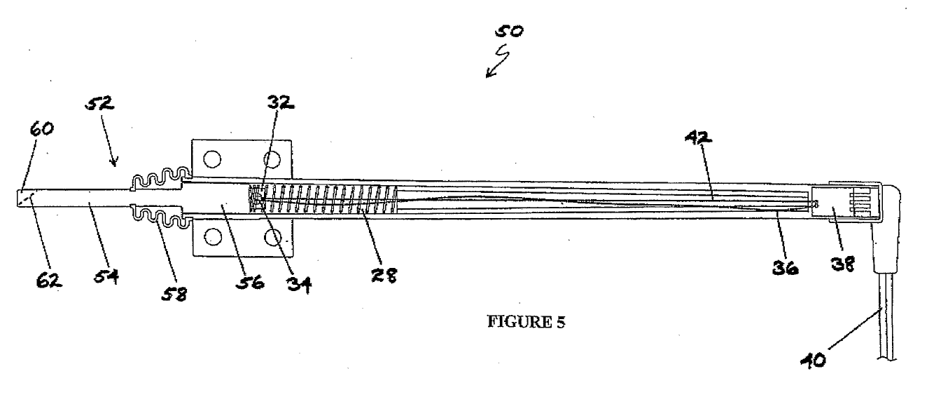

Fastener assembly 10 as illustrated in FIGS. 1 to 4 is a type of “inline” fastener. Fastener assembly 50 illustrated in FIG. 5 is another type of “inline” fastener. In this second embodiment, fastener assembly 50 is shown as suitable for use in connection with a fuel filler cap. The engagement means in FIG. 5 may be substituted for engagement means 12 in FIGS. 1 to 4. In FIG. 5, the same parts will be given the same numbers as in FIGS. 1 to 4.

Fastener assembly 50 has engagement means 52 which includes rod 54 (circular in cross section) integral with block 56. Rubber grommet 58 ensures a liquid and gas-tight seal between rod 54 and the mechanism of fastener assembly 50.

Fastener assembly 50 is shown with engagement means 52 in the locking position, so that rod 54 is engaging a fuel filler cap (not shown). Rod 54 may have a squared off end 60 as shown in FIG. 5 or a ramped end 62 as shown in dotted outline. The configuration in this regard will depend on the type of engagement between rod 54 and the fuel filler cap.

Coil spring 28 urges engagement means 52 towards the locking position. Shape memory alloy wire 36, activatable as described above, can contract to draw engagement means 52 to the unlocking position, through attachment of shape memory alloy wire 36 in aperture 34 of projection 32 from block 56. Locking and unlocking generally takes place as described in relation to the embodiment in FIGS. 1 to 4, in relation to contraction of smart memory wire 36.

It is intended that fastener assembly 50 will be located within or close to the fuel filler cavity of a vehicle, activation taking place as the result of pressing a button on the vehicle dashboard or pressing a button on the vehicle key fob.

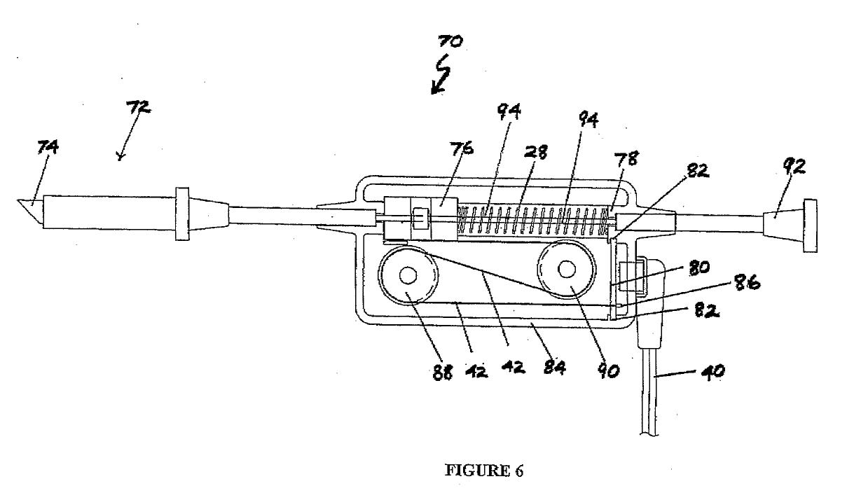

The embodiment shown in FIG. 6 is a fastener assembly 70 for a fuel filler cap which differs from that in FIG. 5 in two respects. Firstly, the embodiment in FIG. 6 permits a longer “travel” for the fuel filler catch. Secondly, the embodiment in FIG. 6 includes a manual override in case there is some malfunction of the activation system from the vehicle dashboard or from the vehicle key fob.

In FIG. 6, fastener assembly 70 has engagement means 72 which includes tongue 74. Engagement means 72 is biased towards the locking position, as shown in FIG. 6, by coil spring 28, which in this embodiment is positioned between block 76 and housing portion 78.

Shape memory alloy wire 42 is attached at one end to block 76 and at the other to panel 80 retained in channels 82 within housing 84. Shape memory alloy we 36 travels from panel 80, where it is fixed through stop 86, over spindle 88, from there to spindle 90 and then to block 76. This greatly increased the length of shape memory alloy wire 36 which in turn enables a greater distance of travel for engagement means 72.

The embodiment in FIG. 6 includes manual override pull 92, which is attached to block 76 by wires 94. Wires 94 are not of shape memory alloy wire and simply provide a mechanical connection between pull 92 and block 76. In case of failure of shape memory alloy wire 36 to be activated through power provided by an external source (not shown) through wires 40, pull 92 may be used to mechanically draw engagement means 72 to the right of the position shown in FIG. 6, disengaging tongue 74 from the fuel filler cap (not shown).

Fastener Assembly with Protection for Contractible Material

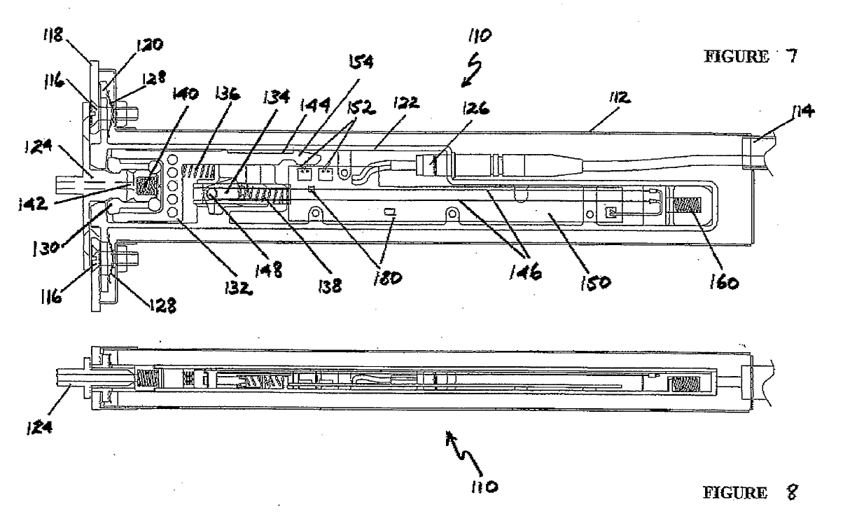

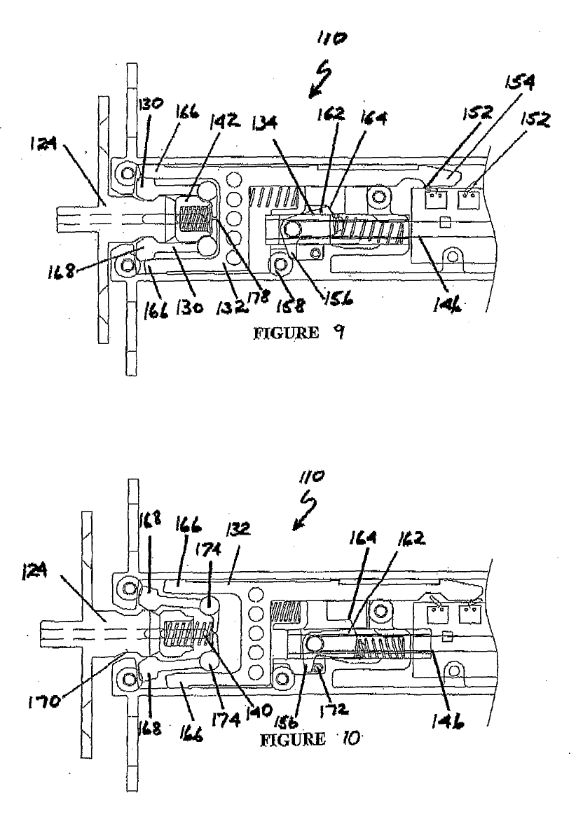

As shown in FIGS. 7 to 12, fastening system 110 is contained within fastener mounting box 112 attached to an external power source through conduit 114. Fastening system 110, contained within box 112, is inserted into a panel (not shown) and secured in position by screws 116 attaching face plate 118 to flange 120 of fastener case 122, contained within box 112. Electrical connection via conduit 114 is continued into fastener case 122 by means of cable connector 126. Spring clip 128 is inserted beneath flange 120.

Fastening system 110 is intended to engage projection 124 (as shown in FIGS. 7 to 9), projection 124 protruding from a panel or door (not shown). In fastening system 110, the engaging means includes latch arms 130, shuttle 132 and pawl 134 Spring 136 biases shuttle 132 towards the locking position shown in FIG. 7. Spring 140 urges ejector plug 142 towards the unlocked position. Shuttle 132 includes Teflon pad 144 to facilitate sliding of shuttle 132 within fastener case 122.

Fastening system 110 also includes shape memory alloy wire 146 which loops over pin 148 on pawl 134. Activation of wire 146 is controlled though printed circuit board sub-assembly 150. Spring 138 is for urging shape memory alloy wire, 146 (or pawl 134?) to the locked position shown in FIG. 7.

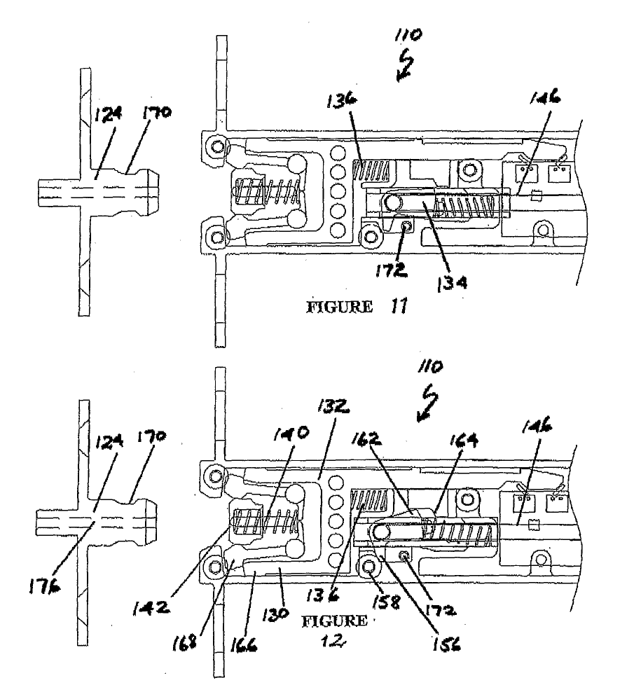

Sensor switches 152 contact extension 154 of shuttle 132 in order to provide an indication of the locked or unlocked status of fastening system 110. As shown in FIG. 9, only one sensor switch 152 is in contact with extension 154 and assembly 110 can therefore indicate that the system is in the locked position. When both sensor switches 152 make contact with extension 154 as shown, for example, in FIG. 12, the indication is that assembly 110 is in the unlocked state.

As shown in FIGS. 7 and 8, assembly 110 also includes spring 160 to relieve strain on shape memory alloy wire 146 should it be unable to draw pawl 134 away from the locking position.

Referring now to FIG. 9, fastening system 110 is shown in the locked position. In this position, projection 156 on pawl 134 bears against pin 158 and ramp 162 engages shoulder 164 of shuttle 132.

Ends 166 of shuttle 132 bear against ends 168 of latch arms 130 ensuring engagement of ends 165 with recess 170 in projection 124 (see FIG. 10).

When sufficient electrical energy is applied through the electrical connection via cable connector 126, wire 146 contracts, drawing pawl 134 away from the locking position, as shown in FIG. 10. In this position, ramp 162 of pawl 134 has pushed against shoulder 164 until projection 156 has encountered travel limit pin 172, which has pivoted ramp 162 away from full contact with shoulder 164, as shown in FIG. 10. At this stage, wire 146 is still contracted. The withdrawal of shuttle 132 has moved ends 166 of shuttle 132 out of contact with ends 168 of latch arms 130. Latch arms 130 pivot around pivot points 174 and move out of engagement with recess 170 of projection 124. Ejector spring 140 pushing against ejector plug 142 has caused partial ejection of is projection 124 from fastening systems 110.

It will be appreciated that if travel limit pin 172 is removed, pawl 134 will pivot so that there is no contact with shoulder 164 at all. Shuttle 132 will then be free to move towards the locking position under the influence of spring 136. Projection 124 can then be engaged with fastening system 110. However, unlocking will not be possible until wire 146 has cooled sufficiently.

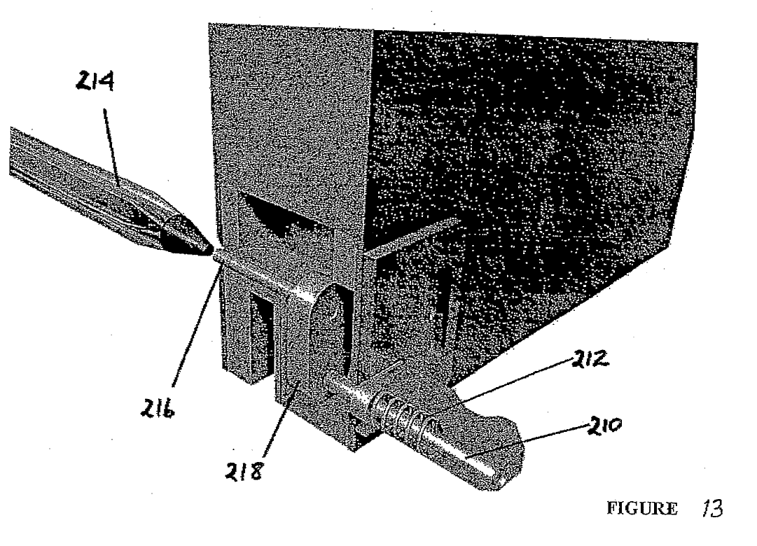

In the next stage shown in FIG. 11, projection 124 has been ejected completely from fastening system 110. Wire 146 has elongated to some extent while cooling and so pawl 134 has been able to move out of contact with pin 172.

In the configuration shown in FIG. 12, wire 146 has completed elongation through cooling, pawl 134 has moved sufficiently away from pin 172 so that projection 156 has contacted pin 158, causing pawl 134 to pivot so that ramp 162 is in position to engage shoulder 164.

If projection 124 is pushed into fastening system 110 at this point, ejector plug 142 mill be compressed against spring 140, ends 168 of latch arms 130 will snap into place into so recess 170, ends 166 of shuttle 132 will be able to move into position against ends 168 of latch arms 130, spring 136 will move shuttle 132 to the left in FIG. 12 and ramp 162 will engage shoulder 164 of shuttle 132, ready for unlocking if wire 146 is activated.

Aperture 176 though projection 124 is available for use as a light pipe—for example, for indication of looked or unlocked state. In addition, a suitable tool can be inserted though aperture 176, trough an aperture (not shown) in ejector plug 142 and though gap 178 (see FIG. 9) between latch arms 130. The tool can then exert pressure on shuffle 132 to manually move shuttle 132 towards the unlocked position, whereupon the contact between ends 166 and ends 168 will be removed, allowing ejection of projection 124 out of fastening system 110.

Release for Locking Assembly

Referring to FIG. 13, this is an alternate manual override mechanism which could be used, for example, with the fourth embodiment latch system shown in FIGS. 7 to 12. In the FIG. 13 embodiment, pin 210 is available to release locking means (shuttle) 132, if pushed sufficiently against the bias of spring 212. To cause pin 210 to move sufficiently in this way to disengage the original latch system (not shown in FIG. 13), a suitable tool 214 is used to push second pin 216. Second pin 216 is connected to intermediate element 218, which also connects to pin 210.

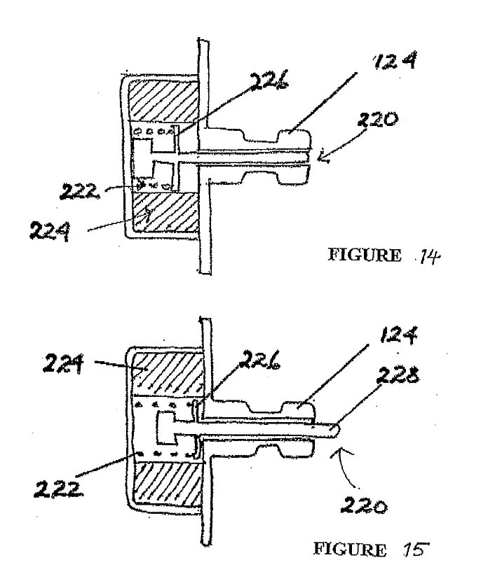

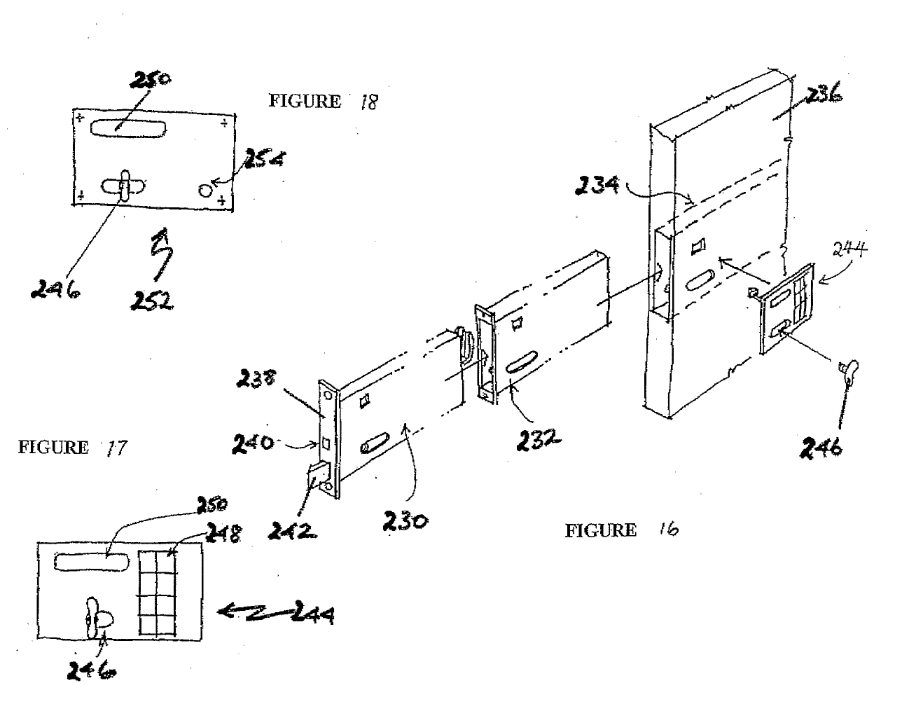

Turning now to the embodiment in FIGS. 14 and 15, FIG. 14 shows the normal “power on” mode. In this mode, release pin 220 is biased towards engagement with the locking means (not shown in this Figure) by spring 222. However, spring 222 is held in a coiled configuration by solenoid electromagnet 224.

In the event of a “power off” situation, solenoid electromagnet 224 switches off. Spring 222 is no longer held in the coiled position and is free to exert force on flange 226 of pin 220, which accordingly is pushed to the right as viewed in FIG. 15. Point 228 of pin 220 engages the base 133 of locking means (shuttle) 132 (refer FIGS. 9 and 10) to push it out of engagement with latch means 130, enabling release of the fastening system 110. In FIGS. 14 and 15, pin 220 is shown as inserted into stud 124 (projection) of FIGS. 7 to 12.

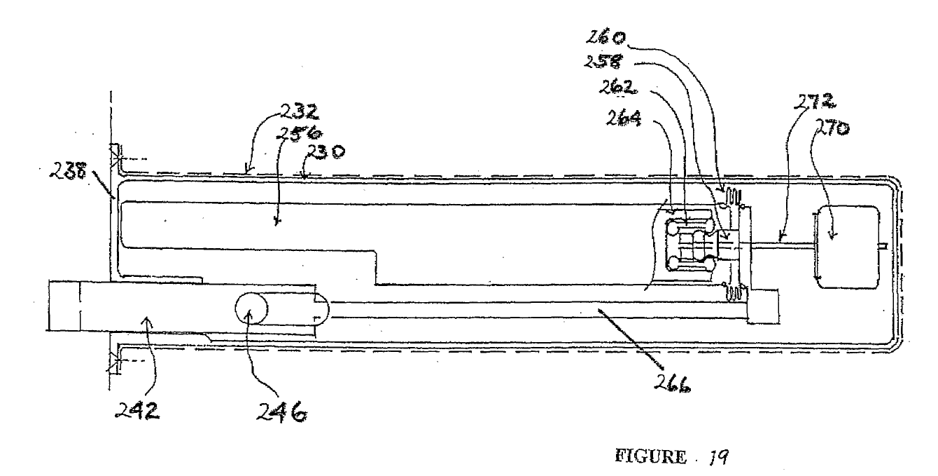

Reference is now made to the sixth embodiment in FIGS. 16 to 22. As can be seen in FIG. 16, a releasable fastener system according to this embodiment of the invention is contained in housing 230 into which the mechanism can be sealed. Housing 230 is in turn inserted in case 232 and the assembly housed in rebate 234 in door 236. It will be noted that latch plate 238 on housing 230 includes sensor 240 for detecting whether door 236 is closed or open. Latch plate 238 also, of course, provides an aperture for latch tongue 242.

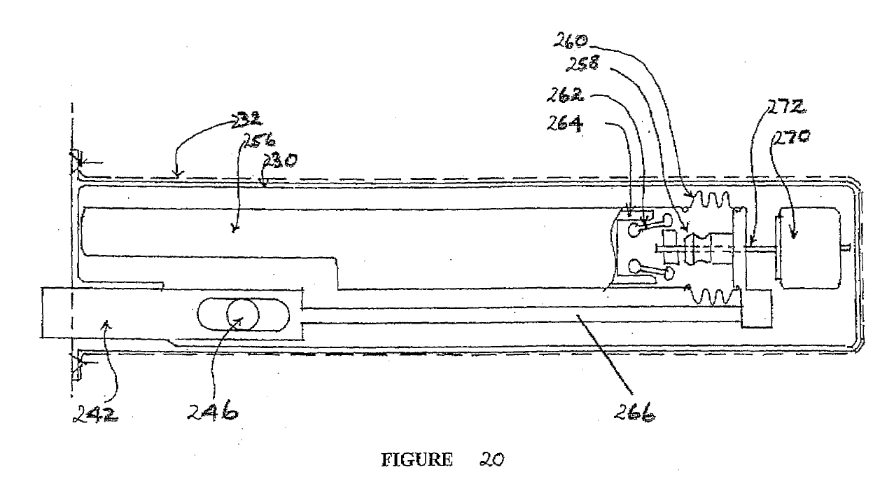

On the side of door 36 external to the crew compartment is escutcheon plate 244, which is shown in more detail in FIG. 17. Slide handle 246 is inserted through escutcheon plate 244.

As can be seen from FIG. 17, escutcheon plate 244 includes key pad 248 and, in this embodiment, status touch pad 250. Key pad 248 is a suitable key pad which facilitates the security and programming functions required. Key pad 248 may include an LED indicator or other display or indicator, providing visual or other sensory feedback of open, closed and programming status.

On the internal side of door 236—for access from inside the crew compartment, is escutcheon plate 252, illustrated in FIG. 18. This includes a status touch pad 250 and a slide handle 246, like plate 244. It also includes an emergency release 254, which can independently operate a power down release device, such as that shown in FIGS. 14 and 15.

In FIG. 19, the fastening system of the invention is shown in the “deadbolt” state. In this mode, latch 242 has been moved by activation of the drawing means—shape memory alloy, shuttle and electronics indicated generally at 256 (see FIG. 7 for details).

In contrast to the latch release system shown in FIGS. 7 to 12, the embodiment illustrated in FIGS. 19 to 22 has a stud or locking pin 258 located internally of sealed latch housing 230. To enhance the hermetic seal, a flexible seal is included, as shown at 260.

Pin 258 is shown as locked into latch arms 262 received in locking means or locking shuttle 264. In this embodiment, pin 258 is attached to rod 266, which in turn drives latch 242.

The “power down” release device is indicated generally at 270 and includes release pin 272. The power down release device 270, including pin 272, is designed to act basically in the same manner as the fifth embodiment shown in FIGS. 14 and 15.

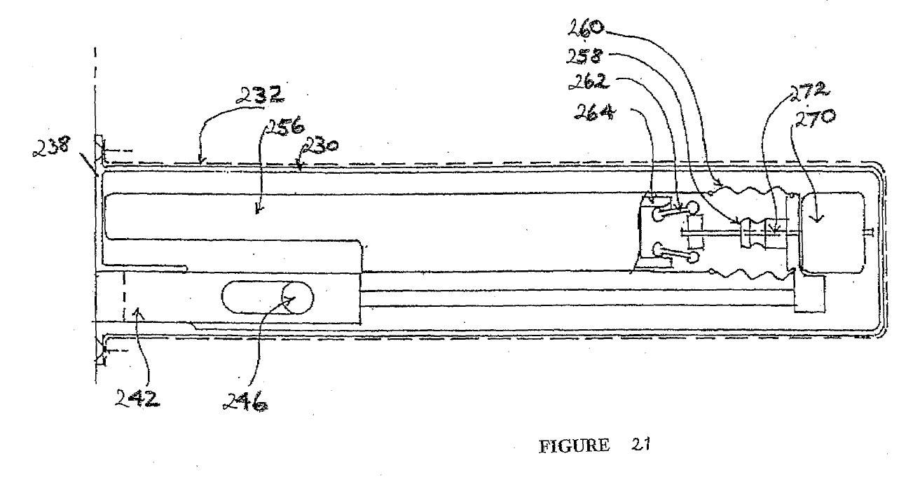

The latched mode is shown in Figure 20. Latch 242 is no longer dead bolted, because looking shuttle 264 has been withdrawn from engagement with latch ann 262 and locking pin 258 has been released. There has been no change in the status of power down release device 270. To open the crew compartment door, handle 246 can be pulled to the right in FIG. 20, to the position shown in FIG. 21, so that latch 242 withdraws behind latch plate 238. It will be noted that locking pin 25$8 has moved to the right to abut power down release device 270, but that there has been no change in the status of power down release device 270.

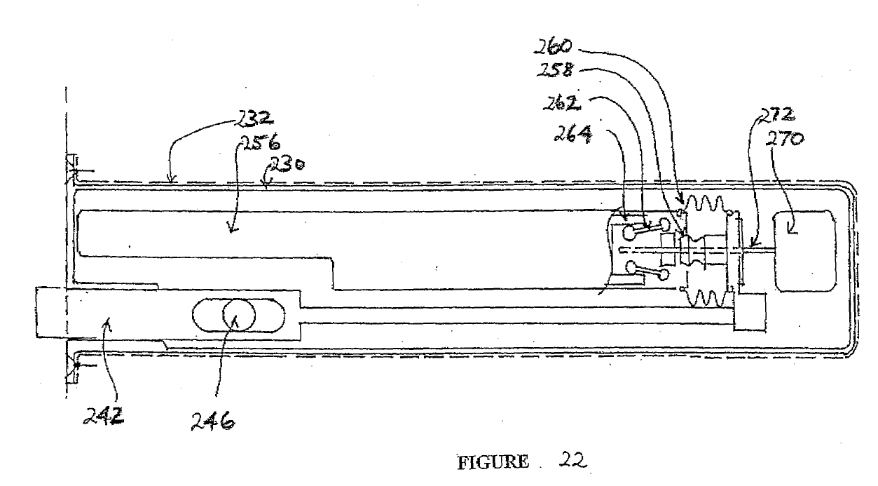

In FIG. 22, power down release device 270 has been activated, It will be noted that release pin 272 has been released so that it has moved to its maximum extent to the left, to contact locking shuttle 264, freeing latch arms 262 from any previously locked state. Latch 242 is now in the same mode as in FIG. 20 and can be manually retracted in order to allow a crew member to exit the crew compartment.

Through-out the specification and claims the word “comprise” and its derivatives is intended to have an inclusive rather than exclusive weaning unless the context requires otherwise.

It will be apparent that various changes may be made to the invention without departing from the spirit and scope thereof.

1. A fastening assembly including:
an engagement means including latch means and locking means, the engagement means being moveable between a locking position and an unlocking position;
first biasing means urging the engagement means towards the locking position;
drawing means for drawing the engagement means from the locking position to the unlocking position, the drawing means comprising or including material adapted to contract when activated;
release means for moving the locking means to the unlocking position;
second biasing means urging the release means towards the locking means; and
restraining means for restraining the release means against the urging of the second biasing means.

2. The fastening assembly of claim 1, wherein the locking means is a slidable shuttle in which the latch means is generally received.

3. The fastening assembly of claim 1, wherein the latch means includes a pair of arms or jaws which can engage a latch, bar or projection.

4. The fastening assembly of claim 3, wherein the locking means is adapted to embrace the latch means in the locking position and to hold the latch means in locking contact with the latch, bar or projection.

5. The fastening assembly of claim 3, wherein moving the shuttle away from the latch means allows the latch means to release contact with the latch, bar or projection.

6. The fastening assembly of claim 1, wherein the engagement means further includes a pawl to facilitate rapid resetting of the fastener assembly after activation of the drawing means.

7. The fastening assembly of claim 1, further including indicating means to indicate the locked or unlocked states of the fastener assembly.

8. The fastening assembly of claim 2, wherein the first biasing means is a coiled spring positioned in the fastener assembly and adapted to urge the shuttle toward the locking position.

9. The fastening assembly of claim 8, wherein when activated the drawing means causes compression of the first biasing means spring and when no longer activated returns the shuttle towards the locking position.

10. The fastening assembly of claim 6, further including pawl biasing means acting on the pawl and ejection biasing means for urging the latch, bar or projection to eject from the engagement means.

11. The fastening assembly of claim 1, wherein the drawings means material is shape memory material.

12. The fastening assembly of claim 1, wherein activation of the drawings means material is achieved by heat activation.

13. The fastening assembly of claim 1, is wherein the drawings means material is Nitinol wire.

14. The fastening assembly of claim 1, wherein the drawings means material is elongate and arranged in parallel passes to multiply the overall change in length of the drawing means upon activation by increasing its total length of travel.

15. The fastening assembly of claim 1, wherein the activation of the drawing means is initiated from a central location using a wiring system of terrestrial, aircraft, space or marine vehicle.

16. The fastening assembly of claim 1, wherein the activation of the drawing means is initiated from a remote location by remote means using an electromagnetic signal generating device.

17. The fastening assembly of claim 1, wherein the release means is a release pin which is of sufficient length to contact the locking means to disengage it from the latch means.

18. The fastening assembly of claim 3, wherein the release means extends through the latch, bar or projection and the latch means to the shuttle.

19. The fastening assembly of claim 1, wherein the release means is urged toward the locking means by release biasing means and is restrained in a retracted position by a solenoid electromagnet.

20. The fastening assembly of claim 19, wherein in a normal “power on” condition, the solenoid electromagnet will be active and will hold back the release biasing means so that the fastener assembly is only unlocked upon activation of the drawing means and the release means.

21. The fastening assembly of claim 19 when dependent on any one of claims 3 to 20, wherein if a “power off” mode is experienced, the solenoid electromagnet becomes inactive and the release biasing means will release causing the release means to drive forward into the fastener assembly to override the locking means, thereby releasing the latch, bar or projection.

22. The fastening assembly of claim 19, further including a mechanical override to allow mechanical unlocking of the engagement means under all conditions, including the “power on” mode.

23. (canceled)
